(19) United States
(12) Patent Application Publication
(10) Pub. No.: US 2014/0040278 A1
(43) Pub. Date: Feb. 6, 2014

(54) RATING ITEMS BASED ON PERFORMANCE OVER TIME

(71) Applicants: Scott Clearwater, Menlo Park, CA (US); Bernardo Huberman, Palo Alto, CA (US)

(72) Inventors: Scott Clearwater, Menlo Park, CA (US); Bernardo Huberman, Palo Alto, CA (US)

(21) Appl. No.: 13/563,651

(22) Filed: Jul. 31, 2012

(51) Int. Cl. G06F 17/30

(52) U.S. Cl. 707/748; 707/E17.009; 707/E17.032

(57) ABSTRACT

A process can establish respective ratings for items in a list by determining respective measurements of performance of the items during each of a series of time windows. For each of the items and each time window, the process can adjust the rating of an item using multiple adjustments that are respectively associated with competing items in the list. Each of the adjustments may depend on the rating of the item, the rating of the competing item, and whether the measurement of performance of the item is higher than the measurement of the performance of the competing item.

### CROSS-REFERENCE TO RELATED APPLICATIONS

This patent document is related to PCT application PCT/US2011/039037, entitled “Rating Items,” filed Jun. 3, 2011, which is hereby incorporated by reference in its entirety.

### BACKGROUND

The growing amount of information available to users creates a growing need to organize this information into manageable and useful forms. One particular concern is ordering information according to specific criterion, for example, to identify the better, more useful, or more popular items. A variety of ranking systems have been developed that can order a list of items according to such criterion. However, these ranking systems often have limitations. For example, the underlying basis for ordering of items in a list may change or evolve, so that an item may currently deserve a higher or lower rank than previous events indicate. Determining when such changes have occurred and determining when a ranking is outdated may be complicated. Also, the relevant items to be included in a ranking may change, and determining where a new item may fit in a ranking including older items can also be complicated. For example, an older item having a greater number of purchases, favorable reviews, or other events that are relevant to a ranking may or may not deserve to be ranked higher than a newer item having few relevant events on which a ranking can be based.

### BRIEF DESCRIPTION OF THE DRAWINGS

FIG. 1 is a block diagram of a system capable of ranking items.

FIG. 2 is a flow diagram of a process for ranking items.

Use of the same reference symbols in different figures indicates similar or identical items.

### DETAILED DESCRIPTION

Items in an arbitrarily long list that may change can be ordered and reordered in an ongoing manner based on measurements of the performance of the items during a series of time windows. The ordering can be based on a rating system that indicates the relative strength of each item. For example, items that in the past have better performance may achieve a higher rating than items that have received less attention in the past. During each time window, respective measurements of performance for the items can be obtained, and the measured performance for each item can be sequentially compared to the performance measurements of the other items. Each comparison of an item with a competing item indicates whether the item: won, i.e., performed better than the competing item during the time window; lost, i.e., performed worse than the competing item during the time window; or drew, i.e., performed the same as the competing item. Each win, loss, and draw that an item receives during a time window may change the rating of the item, and each change can depend on the current rating of the item, the current rating of the competing item, and whether the item won, lost, or drew against the competing item. In general, a win against a higher rated item may cause a larger rating increase, while a loss against lower rated items causes a larger rating decrease, which may allow the ratings to more quickly rise or fall to appropriate values for current conditions. Each item will generally reach and maintain a rating as long as the underlying basis for the ratings remains constant. Further, a new item added to a list may not be subject to a disadvantage relative to items with long histories of performance measurements because the new item may reach its correct rating relatively quickly.

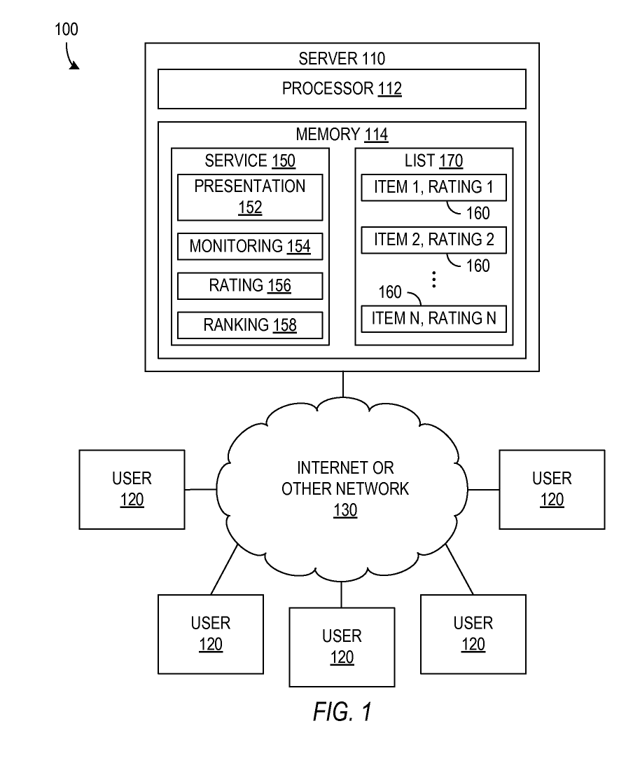

FIG. 1 illustrates an example of a system 100 that may rank items. System 100 particularly includes a computing device 110 connected to communicate over a network 130 with one or more user devices 120. Each device 110 and 120 can be a computer with appropriate software (e.g., executable instructions stored in non-transitory computer-readable media) to perform processes such as described in more detail below. The term computer is used here in a broad sense to include a variety of computing devices such as servers, computer appliances, desktop computers, laptop computers, tablets, game consoles, electronic books, smart phones, other devices having processors or other structures capable of implementing the processes described herein, and combinations of such computing devices that collectively perform the processes described herein.

In an exemplary implementation, device 110 is a server system and network 130 is a wide area network such as the Internet. User devices 120 may be a mixture of different types of devices such as desktop computers, portable computers, tablets, and smart phones that may employ browsers or other applications to communicate with device 110. As will be understood by those of skill in the art, the configuration of devices illustrated in FIG. 1 can be altered in a variety of ways without departing from principles described herein. For example, device 110 might also be employed to perform the functions of user device 120. In one implementation, a single computer acts as all of device 110 and 120, so that network 130 may not be necessary. Also, network 130, when employed, may be a public or a private network of any type. For example, network 130 can be a private local area network or a network providing secure connections for a situation in which the items being ranked are kept confidential. Further, user devices 120 in some implementations may be used in measuring the performance of the items that device 110 ranks In other implementations, the performance measurements may be collected or determined without the need of user devices 120.

A processor 112 in server 110 can execute a service 150 that employs or involves a list 170 of items 160 stored in memory 114. Service 150 may perform a variety of functions for which ordering of items 160 in list 170 is desired. Service 150 may, for example, involve presenting information to users employing user devices 120 that are connected to server 110 through network 130, and an ordering of the items may be desired for creation of an efficient presentation of some or all of items 160. A ranking process can define an order of items 160 in list 170 and can be based on any desired criterion for distinguishing items 160. For example, ranking of items may be based on how much attention users of devices 120 pay to items 160. Ranking of the items 160 in list 170 may alternatively be determined based on criteria that are independent of the users, for example. For example, stocks can be ranked based on daily price gains.

Each item 160 in list 170 may represent almost anything, for example, the items may represent links, documents, products for sale, or investments such as stocks. Similarly, criteria for rating and ranking items 160 may similarly be based on any type of performance associated with items 160. The term performance is used generally herein to reflect a measureable quantity associated with a criterion on which items 160 will be rated and ranked. The possible combinations of types for items 160 and performance measurements used to rate or rank items 160 are unlimited, but some examples are described herein for illustration. For example, if items 160 correspond to links to respective information, one performance measurement is the number of clicks a link receives during a specific time window, and service 150 may rank and display the links/items 160 in order according to which links/items 160 are selected most or least. If items 160 correspond to documents, one performance measure for a document may be the total time that users spend viewing the document, and service 110 may order documents/items 160 according to which documents appear to be of the most or least interest. If the items correspond to stocks listed on an exchange, one measurable characteristic of a stock is the percentage price change each day, and service 150 may rank and display the stocks/items 160 according to which stocks have registered the best price performance over a number of days

Service 150 in the specific implementation of FIG. 1 includes a presentation module 152, a monitoring module 154, and a rating module 156, and a ranking module 158. Presentation module 152 may be used to present items 160 through network 130 and user devices 120 to users. When presenting items 160, presentation module 152 may use the rankings of specific items 160 in list 170 when determining an order in time in which items 160 are presented or when determining positions or order in a display representing one or more of items 160. Monitoring module 154 measures the performances of items 160 during each of a series of time windows. For example, if items 160 are presented to users, monitor module 154 may measure the attention that users pay to each item during a time window. Rating module 156 uses the measurements from monitoring module 154 in determining ratings for each of the items 160, and ranking module 158 uses the ratings to determine a ranking of items 160.

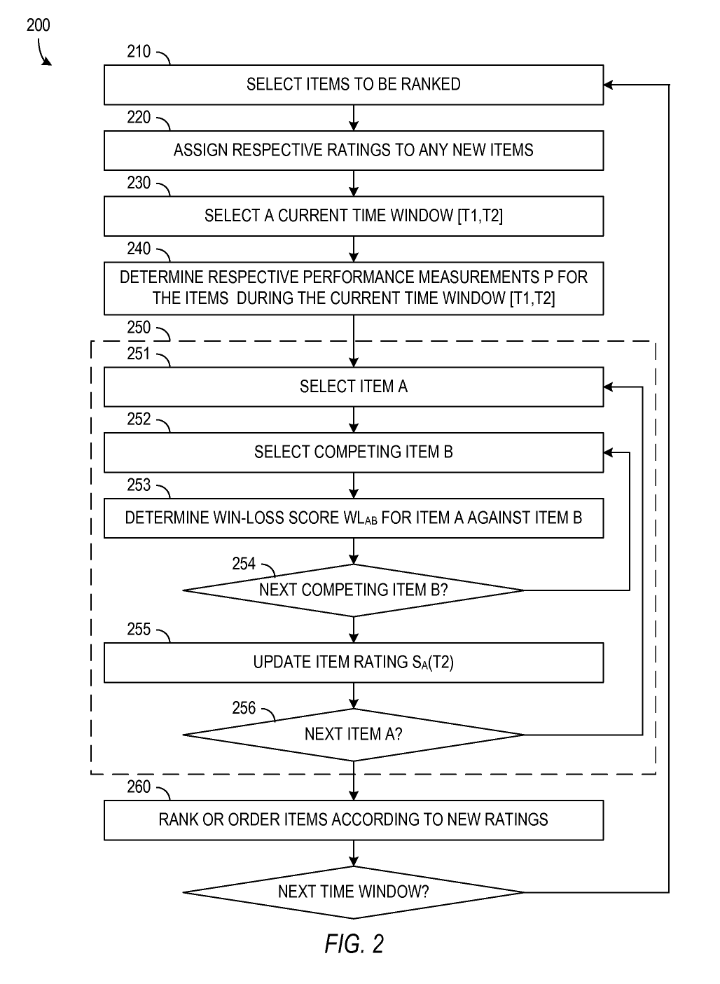

FIG. 2 shows a flow diagram of one implementation of a process 200 for ranking of items. Process 200 begins with selection 210 of the items 160 to be ranked. The items 160 to be ranked are in a list 170 that may change from time to time as one or more items 160 may be added to or removed from the list 170. Block 220 assigns original or provisional ratings to any new items 160 in list 170. The ratings are numeric, e.g., real, rational, or integer values, and may be assigned initial values that are arbitrary in the sense that the initial ratings may not be related to the rating that the item deserves based on the ranking criteria. In one implementation, the original rating of each item may be equal to the average or mean rating of all items 160 in list 170 before the addition or removal of items. If none of the items 160 in the list has a rating, for example, when rating process 200 first begins, items 160 can all be assigned the same average rating, or items 160 could be assigned respective ratings chosen randomly or according to a rule, either of which may provide a desired average value for the ratings of items 160. In general, the original assigned ratings of items 160 are not critical since the ratings may quickly converge to performance-based ratings.

Block 230 selects a current time window [T1,T2], which may be an interval of time that is just beginning However, the rating process could employ historical measurements of the performance of items 160, so that the current time window [T1,T2] does not need to be related to the current time. In FIG. 2, the current time window [T1,T2] has a beginning time T1 and an ending time T2. Each item A in the list has a rating S_{A}(T1) at time T1 that may have been assigned in block 220 or generated in a previous iteration of a rating block 250 for a time interval ending at time T1. Rating block 250, as described further below, can find a rating S_{A}(T2) for each item A at time T2, which is the end of the current time window [T1,T2]. The duration of the current time window [T1,T2] will generally depend on the performance measurement to be performed and may particularly be sufficient to provide a statistically significant measurement.

Block 240 determines respective measurements P of the performance of items 160 during the current time window [T1,T2]. The process for measuring performance will generally depend on the criteria associated with the rating and ranking of items 160. For example, in system 100 of FIG. 1, server 110 may present items 160 in some fashion through user devices 120 to multiple users and may monitor or measure the attention that the users pay to each item 160. For example, for each item 160, server 110 could accumulate the total time that all users spent viewing the item or accumulate the total number of times that all user clicked on or otherwise paid attention to or indicated interest in a representation of the item. However, performance measurements are not limited to user responses and may measure performance during the time window [T1,T2] or may access historic data indicating past performance of the items. Block 240 can thus produce a set of performance scores P_{A} for A=1 to N, where N is the number of items and generally three or more.

Rating block 250 uses the performance scores P_{A} from block 240 and the current ratings S_{A}(T1) for all items A=1 to N to generate adjusted ratings S_{A}(T2) for all items A=1 to N. FIG. 2 illustrates one implementation of rating block 250 that effectively treats the current time window as a competitive process for a given presentation of items 160. In the implementation of FIG. 2, step 250 includes a block 251 that selects an item A from the item list and a block 252 that selects a competing item B from the item list. Item A may win, lose, or draw against item B depending on whether the performance score P_{A} of item A is greater than, less than, or equal to the performance score P_{B} of item B. A block 253 can thus generate a win-loss value WL_{AB} for item A against item B where win-loss value WL_{AB} has value 1, 0, or 0.5 depending on whether item A won, lost, or drew item B during the current time window [T1,T2]. Block 254 can determine whether win-loss values WL_{AB} for an item A have been determined for all competing items B, and if not, the process loops back to block 252 for selection of the next competing item B for item A. Rating process 250 instead branches to block 255 once a complete set of win-loss values for item A is known.

Block 255 can then update or adjust the rating for item A, i.e., determine a new rating S_{A}(T2). In particular, the win-loss values of item A and the ratings for all items at time T1 permit updating the rating of item A using a system similar or identical to the Elö system, which was developed to rank chess players. The new rating S_{A}(T2) for item A can be determined using Equations 1 and 2 in which win-loss values WL_{AB} are for the current time window [T1,T2]. Value E_{AB} can be thought of as an estimated performance of item A relative to item B based on their prior ratings S_{A}(T1) and S_{B}(T1). Factor K affects how quickly a rating converges on a merit-based rating and can be a constant that is selected according to the desired magnitude of adjustments per time window. Factor K could alternatively be a function, for example, that decreases with the number of time windows that process 200 has performed while item A was included in the list. Exponent denominator F in Equation 2 can be a constant or a function selected according to the importance of the divergence between ratings S_{A} and S_{B}. A large value of F means that the score changes more slowly than when F is small. Equation 2 provides one formula for an estimated win-loss value E_{AB} of a higher ranked item A against a lower ranked item B in one implementation of a rating system in which wins and losses respectively count as 1 and 0 and draws count as 0.5. For this specific rating system, the win-loss value WL_{BA} of item B against item A is (1-WL_{AB}), and the estimated win-loss value E_{BA} for item B is (1-E_{AB}). As a result, the change in the rating S_{B} for losing/winning is the negative of the change in rating S_{A} for winning/losing. This characteristic of the rating system maintains the average rating of the items.

$$\begin{matrix}{S}_{A} ( T 2 ) = {S}_{A} ( T 1 ) + K {\sum }_{B \neq A} ( {WL}_{AB} - {E}_{AB} ) & Equation 1 \text{:} \\ {E}_{AB} = \frac{1}{1 + exp [ ( {S}_{B} ( T 1 ) - {S}_{A} ( T 1 ) / F ]} & Equation 2 \text{:}\end{matrix}$$

Equations 1 and 2 provide one implementation of very specific formulae for updating ratings. More generally, for each time window, the rating of an item may be altered by the addition or subtraction of multiple adjustments. Each of the adjustments may be associated with a competing item and have a value that depends on the rating of the item, the rating of the competing item, and whether the performance score of the item is higher than the performance score of the competing item. Also, although Equations 1 and 2 illustrate an example where higher ratings indicate better performance, either higher or lower ratings could indicate better performance. A variety of alternative formulae, conventions, and rules could be employed.

Block 256 can determine whether new ratings S_{A}(T2) for all items A have been determined. If not, the process loops back to block 251 for selection of the next item A. Rating process 250 is complete once new ratings S_{A}(T2) have been determined for all items A. A block 260 can then rank items 160 in list 170 according to their ratings, e.g., with items having higher ratings being followed by items having lower ratings or with items having lower ratings being followed by items having higher ratings.

Rating process 250 can maintain or alter the ratings of items 160 in list 170. In particular, when a much stronger item A wins over a weaker item B during a time window, WL_{AB} is 1, and expected or estimated win-loss value E_{AB} is also near 1. As a result, the rating of the much stronger item A increases only slightly. Similarly, a loss when the item is much weaker than the competing item causes only a slight decrease in the rating of the item. This reflects that the prior ratings appear to still be appropriate. When the ratings items A and B are nearly the same, the adjustments to the ratings of both items A and B will be moderate regardless of which item wins, reflecting that the win or loss may not be statistically significant, but if a trend develops in which one item consistently wins, the rating of the winning item will increase or the losing item will decrease to create separation between their ratings. If a weaker item wins against a much stronger item, the increase in the rating of the weaker item and the decrease in the rating of the stronger item are relatively large. This reflects that the weaker item is not expected to win and that a win suggests that the underlying basis for the prior ratings may have changed in order for the weaker item to win. The large change in rating allows the ratings of the items to adjust relatively quickly to changes in the underlying basis of the rating. As mentioned above, items may be added or removed from the list, and when an item is added, a provisional rating may be assigned. Even if the originally assigned rating is greater or less than the deserved rating for the new item, the adjustments to the rating over several time windows can cause the rating to converge on a deserved rating. The rating and ranking processes described above can thus rapidly deal with changes in the content of the list being evaluated and changes in the underlying basis for the rating or ranking.

Some implementation of the systems and processes described above can be implemented in a computer-readable media, e.g., a non-transient media, such as an optical or magnetic disk, a memory card, or other solid state storage containing instructions that a computing device can execute to perform specific processes that are described herein. Such media may further be or be contained in a server or other device connected to a network such as the Internet that provides for the downloading, streaming, or other use of data and executable instructions.

Although particular implementations have been disclosed, these implementations are only examples and should not be taken as limitations. Various adaptations and combinations of features of the implementations disclosed are within the scope of the following claims.

1. A process comprising:
establishing in a computer respective ratings for items in a list; and
for each of a series of time windows, the computer:
determining respective measurements of performance of the items during the time window; and
for each of the items, adjusting the rating of the item by a plurality of adjustments that are respectively associated with competing items in the list, wherein each of the adjustments depends on the rating of the item, the rating of the competing item associated with the adjustment, and whether the measurement of performance of the item is higher than the measurement of the performance of the competing item associated with the adjustment.

2. The process of claim 1, further comprising ranking the items in the list in an order according to the ratings of the items.

3. The process of claim 2, wherein ranking the items orders the items from highest rating to lowest rating or orders the item from lowest rating to highest rating.

4. The process of claim 1, wherein determining the measurement of performance of one of the items comprises measuring amounts of attention respectively paid to the item by users during the time window corresponding to the measurement.

5. The process of claim 4, wherein measuring amounts of performance comprises determining respective numbers of times that the items were selected by users during the time window.

6. The process of claim 4, wherein measuring amounts of performance comprises determining respective accumulated times that the items were being used during the time window.

7. The process of claim 1, further comprising:
assigning a rating to a new item that is not in the list; and
adding an item to the list at a time between two of the time windows in the series.

8. The process of claim 1, wherein adjusting a rating S_{A}(T1) of one of the items comprises calculating a new rating S_{A}(T2) using
$${S}_{A} ( T 2 ) = {S}_{A} ( T 1 ) + K {\sum }_{B \neq A} ( {WL}_{AB} - {E}_{AB} )$$
where:
A indicates the item having rating S_{A}(T1);
B is an index for competing items which respectively have ratings S_{B}(T1);
K is a factor;
WL_{AB} has a value depending on the performance measurement for the item A and the performance measurement for the competing item B; and
E_{AB} depends on the ratings S_{A}(T1) and S_{B}(T1).

9. The process of claim 8, wherein
$${E}_{AB} = \frac{1}{1 + exp [ ( {S}_{B} ( T 1 ) - {S}_{A} ( T 1 ) / F ]}$$
for some exponent denominator F.

10. The process of claim 8, wherein the factor K is one of a constant and a function of the number of times the rating of the item A has been adjusted.

11. The process of claim 8, wherein WL_{AB} is a win-loss value and is equal to 1 if the performance measurement for the item A is greater than the performance measurement for the competing item B, is equal to 0.5 if the performance measurement for the item A is equal to the performance measurement for the competing item B, and is equal to 0 if the performance measurement for the item A is less than the performance measurement for the competing item B.

12. A non-transient computer readable medium containing program instructions that when executed by a computer perform a process comprising:
establishing in the computer respective ratings for items in a list; and
for each of a series of time windows, the computer:
determining respective measurements of performance of the items during the time window; and
for each of the items, adjusting the rating of the item by a plurality of adjustments that are respectively associated with competing items in the list, wherein each of the adjustments depends on the rating of the item, the rating of the competing item associated with the adjustment, and whether the measurement of performance of the item is higher than the measurement of the performance of the competing item associated with the adjustment.

13. An apparatus comprising:
memory containing a list of items and respective ratings of the items;
a monitoring module configured to measure of respective performance of the items during each of a series of time windows; and
a rating module configured to adjust the ratings of the items for each of the time windows, wherein for each of the items, adjusting the rating of the item includes a plurality of adjustments that are respectively associated with competing items in the list, wherein each of the adjustments depends on the rating of the item, the rating of the competing item associated with the adjustment, and whether the measurement of performance of the item is higher than the measurement of the performance of the competing item associated with the adjustment.

14. The apparatus of claim 13, further comprising a ranking module configured to rank the items in the list in an order according to the ratings of the items.

15. The apparatus of claim 13, wherein the rating module adjusts a rating S_{A}(T1) of one of the items by calculating a new rating S_{A}(T2) using
$${S}_{A} ( T 2 ) = {S}_{A} ( T 1 ) + K {\sum }_{B \neq A} ( {WL}_{AB} - {E}_{AB} )$$
where:
A indicates the item having rating S_{A}(T1);
B is an index for competing items which respectively have ratings S_{B}(T1);
K is a factor;
WL_{AB} has a value depending on the performance measurement for the item A and the performance measurement for the competing item B; and
E_{AB} depends on the ratings S_{A}(T1) and S_{B}(T1).

16. The non-transient computer readable medium of claim 12, wherein the computer, when executing the program instructions, adjusts a rating S_{A}(T1) of one of the items comprises by calculating a new rating S_{A}(T2) using
$${S}_{A} ( T 2 ) = {S}_{A} ( T 1 ) + K {\sum }_{B \neq A} ( {WL}_{AB} - {E}_{AB} )$$
where:
A indicates the item having rating S_{A}(T1);
B is an index for competing items which respectively have ratings S_{B}(T1);
K is a factor;
WL_{AB} has a value depending on the performance measurement for the item A and the performance measurement for the competing item B; and
E_{AB} depends on the ratings S_{A}(T1) and S_{B}(T1).
